(19) United States
(12) Patent Application Publication
(10) Pub. No.: US 2004/0268336 A1
(43) Pub. Date: Dec. 30, 2004

(54) System and method for equipment automation program refresh

(76) Inventors: Chen-Jen Lu, Kaohsiung (TW); Alton Chou, Tainan (TW)

Correspondence Address: THOMAS, KAYDEN, HOSTEMEYER & RISLEY LLP, 100 GALLERIA PARKWAY, SUITE 1750, ATLANTA, GA, 30339, US

(21) Appl. No.: 10/610,043

(22) Filed: Jun. 30, 2003

(51) Int. Cl. G06F 9/44

(52) U.S. Cl. 717/168; 717/103

(57) ABSTRACT

A system and method for Automatic Equipment Automation Program (EAP) refresh. The system includes a server unit, a host unit and an equipment installation. The server unit manages multiple host units to control EAP versions and distribute new EAP versions. The server unit stores new EAP versions and their records, and distributes the versions to the host units. The host unit refreshes EAP after receiving an offline request from the equipment installation. The equipment installation notifies the host unit when entering another phase of automation.

### BACKGROUND OF THE INVENTION

1. Field of the Invention

The present invention relates to program refresh systems, and more particularly, to a method and system of automated refresh EAPs used in a manufacturing factory.

2. Description of the Related Art

Program refresh systems have been used in a variety of program refresh process for safe and efficient automated refresh or upgrade of programs.

In semiconductor manufacturing, a Manufacturing Execution System (MES) and equipment installations communicate via numerous host Personal Computers (PCs) FIG. 1 is a diagram of the architecture of the conventional manufacture automation system. The Manufacturing Execution System (MES) 110 connects to host computers 120, 121, and the host computer 120 connects to equipment installations 130, 131. Equipment Automation Program (EAP) is embedded in the host computer for transferring messages and issues a command between the MES and equipment. Operators write numerous program codes in the EAP to control equipment, query data, and receive messages from equipment. The EAP is an event-driven program, to receive events from MES or equipment installations, taking suitable action. More specifically, the MES follows a standard process steps to send messages to the EAP, and the EAP takes actions to control manufacturing equipment installations based thereon. For example, when receiving an equipment status query from MES, the EAP makes a status query to the equipment installation, and returns relevant status information to the MES.

Commonly, there are five phases during the cycle of equipment installations automation, online request, loading, processing, unloading, and offline request, in sequence. At the beginning of the online request phase, equipment installations send an online request message to the host computer, namely EAP, which prepares to run manufacturing process. The equipment installations enter the loading, processing, and unloading phases in sequence. The equipment installation stops and enters offline phase after finishing entire jobs. At the beginning of each phase, equipment installations send suitable messages to the host computer to report current status. Equipment installations often report manufacturing data and critical information, for example, low yield or fatal error, to a corresponding host PC during the processing phase. When equipment installations stop the automated manufacturing process and switch to manual mode, they send an offline request message to host PC.

In the past, manual routine procedures have been used to refresh EAP. Operator uploads a new EAP via computer network to host PC and issues a command to replace the current EAP. After replacement, a routine restart process starts the new EAP. The restart process normally requires execute of a restart program and additional response to information requests as required. It is often necessary to add or revise program codes in EAP, resulting in frequent EAP refreshment.

In EAP refreshment, several problems need to be solved. EAP refreshment is risky when equipment installations are working, threatening automation process and jeopardizing critical information during the manufacturing process. It is therefore necessary to choose the proper time to refresh the EAP. Since many EAP versions are deployed according to equipment varieties, negligence in refreshing EAP can result in unexpected errors or failure to execute proper operations.

To address the situation described, operators must be notified to clean up and stop equipment, refresh the EAP manually, and finally, restart all equipment individually. Although the solution is feasible, several problems remain. First, extensive operator labor is entailed in stopping and cleaning equipment installations to refresh EAP. Second, much time is spent checking and monitoring EAP versions for individual equipment installations and tracking refresh progress. Frequently, more time is spent refreshing than revising EAP. Finally, equipment installations are forced to interrupt operations during the EAP refreshment process, eliminating the utility of production.

In view of these limitations, a need exists for a system and method of efficient and reliable EAP refresh that reduces refresh time and improves equipment installations utilization, and also provides security during the automated refresh process.

### SUMMARY OF THE INVENTION

It is therefore an object of the present invention to provide a system and method of automated refresh for Equipment Automation Program (EAP) versions to reduce refresh time. To achieve the above object, the present invention provides a system and method of automated refresh EAP versions in a secure time.

According to the embodiment of the invention, the system includes a server unit, a host unit, and equipment installation. The server unit includes a program version database, EAP storage, a distribution unit, and a monitor unit to distribute EAP versions to the host unit. The host unit includes EAP storage and a program refresh unit to automatically refresh EAP. The equipment installation notifies the host unit when entering another phase of operation.

According to the invention, a method of automated refresh EAP performs the following steps. First, the distribution unit of the server unit detects new EAP versions in EAP storage and uploads them to the host unit. The program refresh unit of the host unit detects the new EAP when it receives an offline request message from the equipment installation. After that, the program refresh unit replaces the current EAP, restarts the new EAP and awaits a refreshment completion notification from the new EAP. After it receives the refreshment completion notification, sends an update request to the server unit to update related program version record in the program version database thereof.

### BRIEF DESCRIPTION OF THE DRAWINGS

The present invention can be more fully understood by reading the subsequent detailed description and examples with references made to the accompanying drawings, wherein:

FIG. 1 is a diagram of the architecture of a conventional manufacturing automation system;

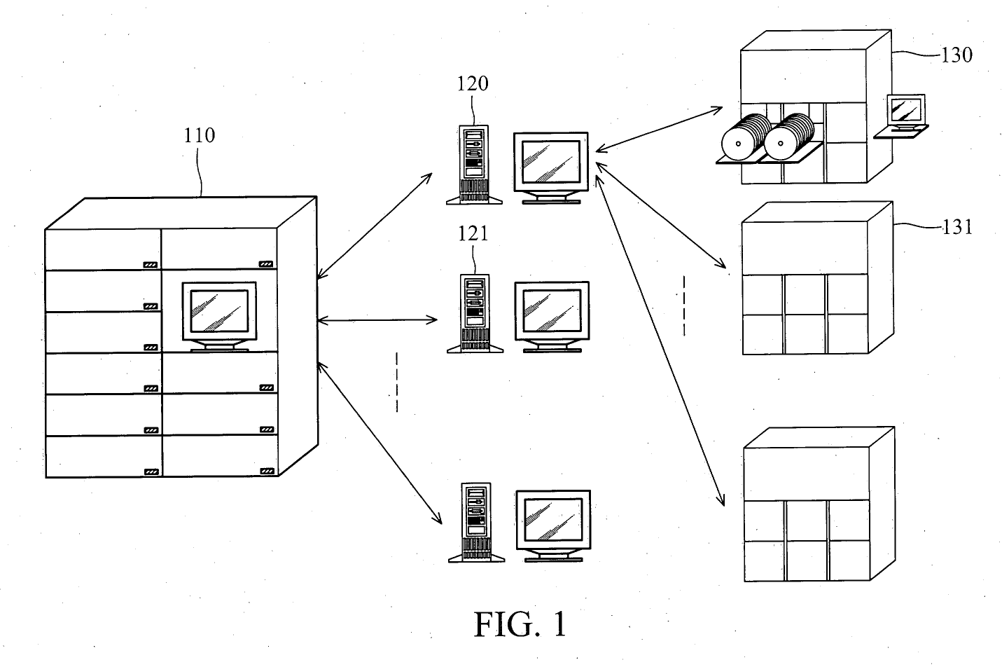

FIG. 2 is a diagram of the architecture of a system for automated Equipment Automation Program (EAP) refresh according to the invention;

FIG. 3 is a flowchart showing the method of automated Equipment Automation Program (EAP) refresh according to the invention;

FIG. 4 is a diagram of a storage medium for storing a computer program providing the method of automated Equipment Automation Program (EAP) refresh according to the invention.

### DETAILED DESCRIPTION OF THE INVENTION

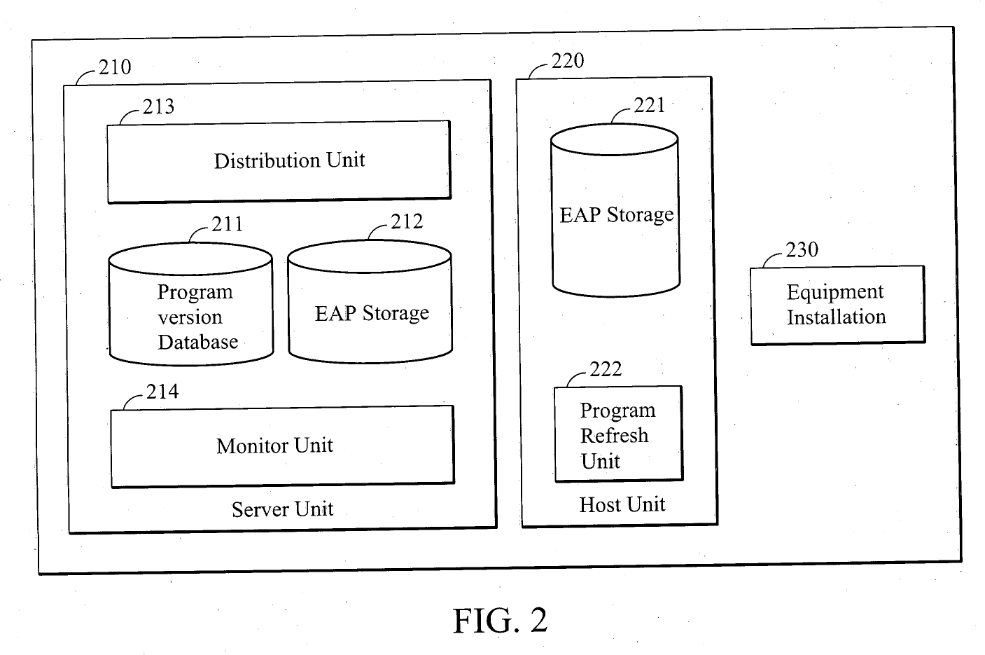

FIG. 2 is a diagram of the architecture of the system for automated Equipment Automation Program (EAP) refresh according to the present invention. The system includes a server unit 210, a host unit 220, and equipment installation 230. The server unit 210 manages EAP versions and EAP version records, and distributes EAP versions to the host unit 220. The server unit described can be implemented in a PC, workstation or mainframe. The server unit 210 preferably handles a plurality of host units 220 for more effective control of EAP versions. The host unit 220 is responsible for storing and, most importantly, refreshing EAP versions. The host unit 220 can be implemented in a PC, workstation, or mainframe. The equipment installation 230 is an automatic semiconductor manufacturing tool or machine, such as a tracker or a stepper that performs a series of semiconductor manufacturing operations. One host unit hosts multiple equipment installations via EAP versions to receive messages from MES or equipment, and take further action according thereto. The server unit 220 communicates with host units 230 via a communication protocol, such as NetBEUI or TCP/IP.

Four components are included in the server unit, a program version database 211, EAP storage 212, a distribution unit 213, and a monitor unit 214. The program version database 211 stores multiple EAP version records including four fields, equipment installation and EAP identities, program version, and host identity. The EAP identity field is a primary key in the database and stores the EAP identifier, preferably the same as the EAP filename. The equipment installations identity field is a foreign key that stores the physical equipment installations identifier the EAP handles. The host identity field is a foreign key storing the physical host PC identifier wherein the EAP resides. The program version field stores version information of the EAP in current use and is often date compounded to indicate a start date for the EAP. EAP storage 212 stores EAP versions temporarily for further distribution, and can be a computer hard disc drive, a virtual directory, or a virtual folder of a virtual directory. After complete enhancement of function and error correction, a new EAP is sent to storage 212. Preferably, the EAP file name follows a naming rule identifying relevant equipment installations and version of the EAP, for example, EAP TT18SL01.TAP hosts equipment installation TT18SL01 and is currently in use, and EAP TT18SL01.NEWTAP is a new EAP version of TT18SL01. Distribution unit 213 detects new EAP versions and distributes them to the relevant host units. For instance, EAP TT18SL01.NEWTAP in EAP storage generates host identifier CPPHA1 from the EAP version record and is then distributed to the host CPPHA1. Distribution unit 213 provides a Graphic User Interface (GUI), making EAP versions easier to distribute. It can also configure distribution parameters, such as distribution time, destination hosts, and others. The monitor unit 214 provides EAP summaries from the program version database 211 to user, generated summaries using Standard Query Language (SQL) issues a command via Open DataBase Connectivity (ODBC) drivers. Summaries include non-refreshed EAP, EAP profile, EAP refreshment details, and others.

The host unit 220 comprises EAP storage 221 and program refresh unit 222. EAP storage 221 stores current EAP versions and receives new EAP versions from both automated distribution servers and users. The kernel component, program refresh unit 222, detects equipment installations status, detects new EAP versions, replaces current EAP with new EAP, restarts new EAP, detects a refreshment completion notification from new EAP, and sends an update request to the server unit to update a program version record.

The program refresh unit 222 detects equipment installations status by messages from equipment. Five typical messages include online request, loading, processing, unloading and offline request, entering equipment installations into subsequent phases of automation. Offline request messages are tracked, and subsequent refresh operations are executed. In the loading, processing and uploading phase, EAP refresh may impact the automated manufacturing process or lose critical information, such as low yield, product scrap, or others. In the online request phase, EAP refresh can waste much time waiting for updated refresh process. The operations described above can be implemented in an method of program code.

The program refresh unit 222 executes subsequent refresh operations after detecting an offline request message. First, new EAP files are matched with equipment installations by file names or version information extracted from program code in EAP storage 221. When detecting a new EAP version, it replaces the current EAP with the new EAP, otherwise, stops operations and awaits messages from equipment. The replace operation, for example, deletes the current EAP, updates the filename of new EAP, and restarts the new EAP. After successful restart, the new EAP with a refreshment completion notification method triggers or sends a message with a refresh date to the program refresh unit 222 to indicate that the restart procedure is completed. Finally, it sends the update request with a refresh date to the server unit 210 to update the version record such that the record in server unit 210 reflects the EAP refresh.

Equipment unit 230 is responsible for notifying the host unit 220 it has entered another phase. For instance, equipment installations send an offline request message to the host unit 220 when it is switched to manual process.

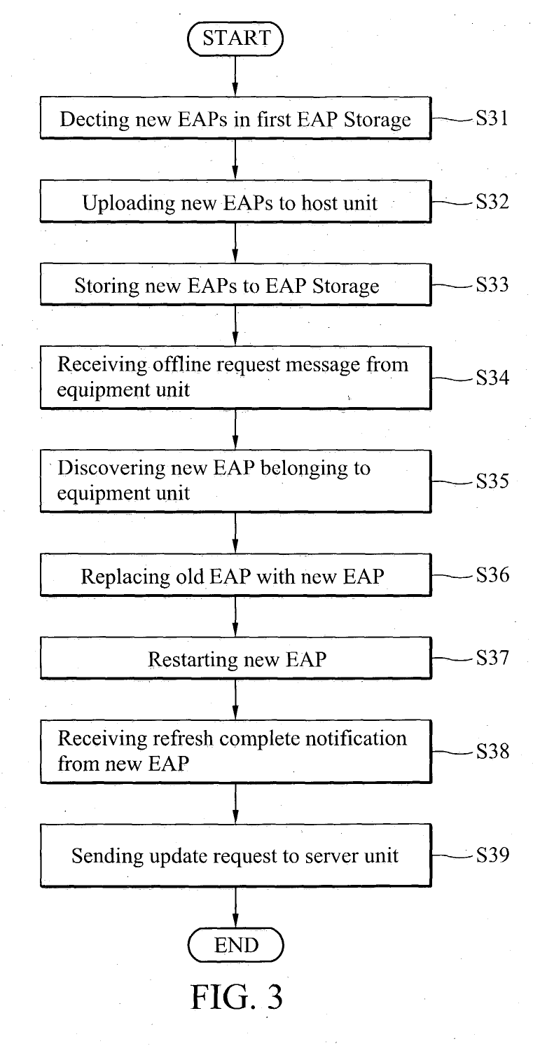

FIG. 3 is a flowchart showing the method of refreshing EAP according to the present invention.

In the server unit 210, first, in step S31, the distribution unit 213 detects new EAP versions in EAP storage 212. As well as the automatic detection described above, in this step, new EAP versions can also be chosen by operator from the Graphic User Interface (GUI) or Web GUI application. Among several means of detecting new EAP versions, one example scans EAP storage 212 and detects files “.NEWTAP”. Then, in step S32, the distribution unit 213 uploads the new EAP to the host unit 220 via ftp or NetBEUI.

In the host unit 220, as in step S33, the program refresh unit 222 receives new EAP versions from the distribution unit 213 and stores them to EAP storage 221. Then, it tracks requests from equipment installation 230. After the program refresh unit 222 receives an offline request message from equipment installation, as in step S34, it detects the new EAP belonging to equipment installations in the EAP storage 221 as in step S35, ignoring messages other than offline requests. Possible means of detecting new EAP include file name comparison, program version comparison or comparison of version information extracted from EAP source code. In step S36, the current EAP is replaced, and the new EAP is restarted as in step S37. After it receives refreshment completion notification as in step S38, it sends an updated request to the server unit S39 to update the version record. The refreshment completion notification and the update request include information of host identity, EAP identity, equipment installation identity, and refresh date. The program version record includes equipment installation identity, EAP identity, host identity, and current program version.

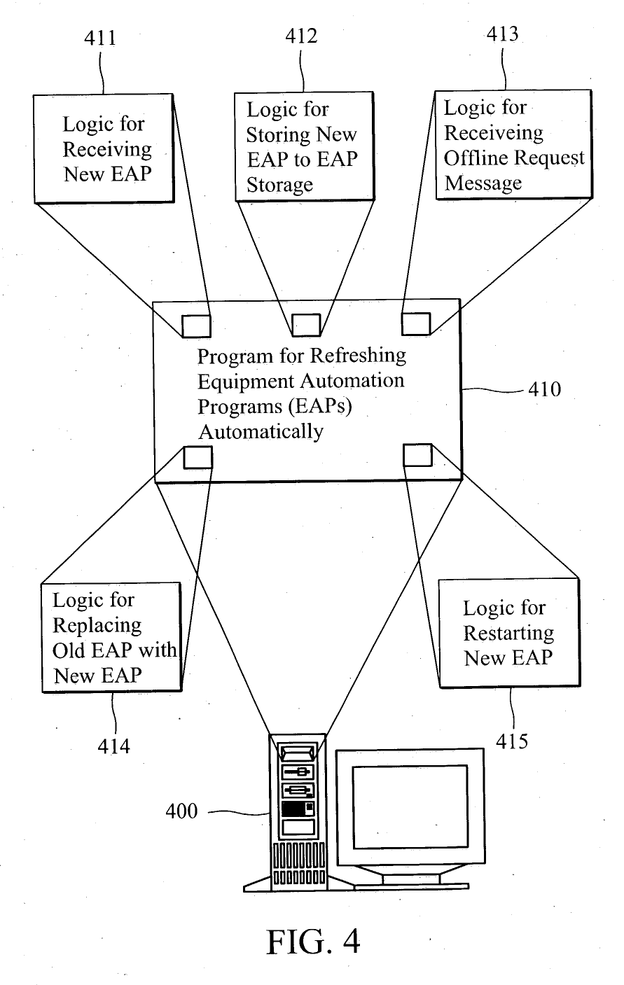

In addition, the invention discloses a storage medium for storing a computer program providing the disclosed method of EAP refresh, as shown in FIG. 4.

Although the present invention has been described in its preferred embodiments, it is not intended to limit the invention to the precise embodiments disclosed herein. Those who are skilled in this technology can still make various alterations and modifications without departing from the scope and spirit of this invention. Therefore, the scope of the present invention shall be defined and protected by the following claims and their equivalents.

What is claimed is:

1. A system of refreshing an EAP (EAP), comprising:
a server unit comprising a program version database storing a plurality of program version records, a first EAP storage storing a new EAP, and a distribution unit for the new EAP; and
a host unit connected to the server unit comprising a second EAP storage unit storing a current EAP and a new EAP received from the distribution unit, and a program refresh unit receiving equipment information and detecting the new EAP in the second EAP storage, replacing the current EAP, restarting the new EAP, tracking a refreshment completion notification from the new EAP and sending an update request to the server unit to update the program version record.

2. The system as claimed in claim 1 further comprising an equipment installation sending the equipment installations status to the program refresh unit.

3. The system as claimed in claim 2 wherein the equipment installation is semiconductor manufacturing equipment.

4. The system as claimed in claim 1 wherein in the host unit, the host unit manages the equipment installation via the EAP.

5. The system as claimed in claim 1 wherein the server unit further comprises a monitor unit generating EAP version summary.

6. The system as claimed in claim 1 wherein the server unit further comprises an application for distributing the new EAP program with a graphic user interface.

7. The system as claimed in claim 1 wherein the program version database, the program version record comprises equipment installation identity, EAP identity, host identity and current program version.

8. The system as claimed in claim 1 wherein the program fresh unit further detecting the new EAP program in the second EAP storage after receiving an offline request message from the equipment installation.

9. The system as claimed in claim 1 wherein in the program fresh unit, the refreshment completion notification comprises a refresh date and version information.

10. A system of refreshing EAP versions, comprising:
an EAP storage unit storing a current EAP and a new EAP corresponding to the current EAP; and
a program refresh unit receiving status information from equipment, detecting the new EAP in the EAP storage, replacing the current EAP and restarting the new EAP.

11. The system as claimed in claim 10 further comprising an equipment installation sending the status information to the program refresh unit.

12. The system as claimed in claim 11 wherein the equipment installations comprise semiconductor manufacturing equipment.

13. The system as claimed in claim 10, wherein the system manages the equipment installation via an EAP.

14. The system as claimed in claim 10 wherein the program refresh unit detects the new EAP after receiving an offline request message from the equipment installation.

15. A method of refreshing EAP, comprising:
detecting a new, EAP via comparison with program version data in a server unit;
uploading the new EAP from the server unit to a host unit;
storing the new EAP to EAP storage in the host unit;
receiving an offline request message from an equipment installation;
replacing a current EAP corresponding to the host unit;.
restarting the new EAP in the host unit; and
the host unit sending an update request to the server unit to update the program version record.

16. The method as claimed in claim 15 further comprising a step of detecting the new EAP in the EAP storage of the host unit.

17. The method as claimed in claim 15 further comprising a step of receiving a refreshment completion notification from the new EAP.

18. The method as claimed in claim 17 wherein the refreshment completion notification comprises a refresh date and a version.

19. The method as claimed in claim 15 wherein in the step of sending the update to the server unit, the program version record comprises equipment installation identity, EAP identity, host identity, and current program version.

20. The method as claimed in claim 15 wherein the equipment installation comprises semiconductor manufacturing equipment.

21. A method of refreshing EAP, comprising:
receiving a new EAP;
storing the new EAP to an EAP storage;
receiving an offline request message from an equipment installation;
replacing a current EAP with the new EAP corresponding to the equipment; and
restarting the new EAP.

22. The method as claimed in claim 21 wherein the new EAP is received from a server.

23. The method as claimed in claim 21 wherein the new EAP is received from a user.

24. The method as claimed in claim 21 wherein the equipment installation comprises semiconductor manufacturing equipment.

25. The method as claimed in claim 21 further comprising a step of detecting the new EAP in the EAP storage.

26. A storage medium for storing a computer program providing a method of refreshing EAP, comprising:
receiving a new EAP;
storing the new EAP to an EAP storage;
receiving an offline request message from an equipment installation;
replacing a current EAP with the new EAP corresponding to the equipment; and
restarting the new EAP.

27. The storage medium as claimed in claim 26 wherein the new EAP is received from a server.

28. The storage medium as claimed in claim 26 wherein the new EAP is received from a user.

29. The storage medium as claimed in claim 26 wherein the equipment installation comprises semiconductor manufacturing equipment.

30. The storage medium as claimed in claim 26 further comprising a step of detecting the new EAP in the EAP storage.
